(19) United States
(12) Patent Application Publication
(10) Pub. No.: US 2009/0248460 A1
(43) Pub. Date: Oct. 1, 2009

(54) INTERACTIVE SMART GAME PLAN

(76) Inventor: Jerome Dale JOHNSON, Bayfield, WI (US)

Correspondence Address: Hershkovitz & Associates, LLC, 2845 Duke Street, Alexandria, VA, 22314, US

(21) Appl. No.: 12/055,299

(22) Filed: Mar. 25, 2008

(51) Int. Cl. G06F 9/44

(52) U.S. Cl. 705/7

(57) ABSTRACT

A method, system and a computer program product for an interactive smart game plan for one or more growth initiatives are provided. The method, system and computer program product include an electronic mail component configured to interact with one or more salespersons by sending one or more personalized electronic mails having growth initiative information personalized to the salesperson, pertaining to the growth initiative. The growth initiative information includes at least one of, sales execution instructions, prospect information, and prospect background information.

### CROSS-REFERENCE TO RELATED APPLICATIONS

This disclosure is related to the disclosure of U.S. patent application titled “Initiative Designer,” filed concurrently herewith, having Attorney Docket No. P68370, the disclosure of which is expressly incorporated by reference herein in its entirety.

### BACKGROUND OF THE DISCLOSURE

1. Field of the Disclosure

This disclosure relates to systems and methods for an interactive game plan that can utilize an interactive smart electronic mail and/or a personalized sales execution electronic mail for growth initiatives.

2. Discussion of Background Information

Previous to this disclosure, there were some applications that only indirectly assisted with growth initiatives. There were no systems that existed that directly help connect the growth initiative to the sales and the execution of the growth initiative by a salesperson.

For example, traditionally, resources such as presentations, case studies, training material as well as tools were placed into channel sales portals, i.e., generic web portals that are not specific to a growth initiative. The salespersons needed to determine what they needed, when they needed it, and then find the resources and tools, combine them and use them in a sales situation. It was therefore up to the salesperson to search the copious amount of information provided in these web portals and determine which information was relevant to the growth initiative and which tools were needed to execute the growth initiative. Most salespersons find this method very frustrating and ultimately do not use the information or tools. When combined with a multitude of concurrent sales promotions, product announcements and other growth initiatives, effective execution by channel partners is sometimes impossible or at least very difficult. There may be no guidance on how the information is combined, and how everything is ultimately executed is based on trial and error via the human experience. There is no system that is salesperson-friendly yet integrated and can proactively communicate with a specific salesperson, a specific prospect, prospect background information, and/or suggested sales execution steps while being capable of training the salesperson for implementing the growth initiative.

### SUMMARY OF THE DISCLOSURE

The present disclosure provides for systems and methods for an interactive game plan that can utilize an interactive smart electronic mail and/or a personalized sales execution electronic mail for growth initiatives.

In one or more embodiments, the systems and methods can utilize electronic mail to proactively communicate to a salesperson at least one of, specific prospect, prospect background information, suggested sales execution steps, training information and training steps so that the salesperson can implement a growth initiative. The systems and methods can utilize electronic mail to allow the growth initiative creator to input specific sales execution steps into the salesperson's calendar. The systems and methods are robust such that they can be generalized for more than one salesperson but can be specific and personalized for an individual salesperson based on the salesperson's needs and potential.

The systems and methods can allow a growth initiative creator to quickly create a growth initiative and then have the growth initiative executed by the same or another salesperson. The systems and methods of the disclosure not only can assist growth initiatives, but can also connect the growth initiative to the sales and the execution of the growth initiative by a salesperson. The systems and methods can convert a growth initiative, which is targeted to a specific set of prospects, to a game plan (activities) for each salesperson associated with the growth initiative in order to maximize revenue for the growth initiative. Once the growth initiative has been designed, published, and a salesperson has accepted the growth initiative, the game plan's activities are integrated into the personal calendar of the salesperson via electronic mail distribution. This integration into the salesperson's personal calendar aids the execution and effectiveness of the growth initiative.

The interactive smart electronic mail that is utilized is dynamically generated and personalized. The interactive smart game plan can be time specific, information specific, or tool specific and has monetary value to not only the salesperson but also to a growing company.

Therefore, according to one aspect of the present disclosure, a system for an interactive smart game plan for one or more growth initiatives is provided, the system including: an electronic mail component configured to interact with one or more salespersons by sending one or more personalized electronic mails having growth initiative information personalized to the salesperson, pertaining to the growth initiative, wherein the growth initiative information includes at least one of, sales execution instructions, prospect information, and prospect background information.

The system can further include a calendar component configured to display information relating to the growth initiative.

The electronic mail component of the system can allow the salesperson to receive personalized training material for the growth initiative. The information relating to the smart game plan and/or the information contained in the electronic mail can be sent or delivered via at least one of, the world-wide web, a local area network and a wide area network.

The system can utilize one or more input components configured to allow a user to input information and/or requirements for the growth initiative (Even though the user, with respect to the initiative designer, can be any person, this user would not typically be a salesperson. The terms “user” and “salesperson” are further defined below with respect to the interactive game plan. However, in this context of the initiative designer, the term “user” is used interchangeably with the terms “growth initiative designer” or “growth initiative creator” when referring to someone who is creating or designing the actual growth initiative using the initiative designer module. Hereinafter, this particular user will be referred to as the “growth initiative creator” in order to more accurately describe the user and to prevent any confusion with other terminologies). This can be accomplished by an initiative designer component that is configured to allow a growth initiative creator to at least one of, create, approve, and publish a growth initiative or display information for others to view once all of the information and/or requirements for the growth initiative have been inputted. The initiative designer component can include at least one database and at least one of, a product selection functionality, a segmentation functionality, an incentive functionality, a game plan functionality, and an analytics functionality. The database can be a relational database. However, modules other than this initiative designer can be used, as long as certain growth initiative information and requirements can be inputted. Upon utilizing such input component(s), and then additional information or requirements regarding the growth initiatives are added and implemented using the systems and methods according to the present disclosure, a successful and operational interactive smart game plan would result or would be “outputted,” having capabilities as described herein.

The electronic mail component of the system can be configured to deliver the growth initiative information to a salesperson at a pre-selected or predetermined time and date.

The system can further include an analytics component configured to analyze the launch and execution process of the growth initiative and to provide indicators generated from usage and activity of the game plan.

The system can further include an opportunity analyzer component configured to identify and prioritize prospects for the growth initiative.

The growth initiative information can be obtained from at least one database. This database can also be a relational database.

The electronic mail component of the system can be configured to allow a growth initiative creator to input specific sales execution steps into the game plan and/or the calendar component.

The electronic mail component and/or the calendar component can be configured to display the growth initiative information to a salesperson at a pre-selected or predetermined time and date.

The growth initiative information or the information relating to the growth initiative can include activities or events associated with a growth initiative. The activities or events can be generated by the system and transferred to the calendar component.

The growth initiative information or the information relating to the growth initiative can include prospect information. The prospect information can include information relating to a collection or a group of accounts or contacts for which a growth initiative is targeted.

According to another aspect of the present disclosure, a method for executing one or more growth initiatives of a smart game plan by one or more salespersons is provided. The method can include: utilizing an electronic mail component to interact with one or more salespersons by sending one or more automated and personalized electronic mails having growth initiative information personalized to the salesperson, pertaining to the growth initiative, wherein the growth initiative information includes at least one of, sales execution instructions, prospect information, and prospect background information.

The method can include utilizing an electronic calendar component to display information relating to the growth initiative.

The electronic mail component can allow the salesperson to receive personalized training material for the growth initiative.

The information relating to the smart game plan and/or the information contained in the electronic mail can be sent or delivered via at least one of the world-wide web, a local area network and a wide area network.

The method can utilize one or more electronic input components to allow a growth initiative creator to input information and/or requirements for the growth initiative. This can be accomplished by utilizing an electronic initiative designer component to allow a growth initiative creator to at least one of, create, approve, and publish a growth initiative or display information for others to view once all of the information and/or requirements for the growth initiative have been inputted. The initiative designer component can include at least one database and at least one of, a product selection functionality, a price functionality and a quote functionality. The database can be a relational database. However, modules other than this initiative designer can be used, as long as certain growth initiative information and requirements can be inputted. Upon utilizing such input component(s), and then additional information or requirements regarding the growth initiatives are added and implemented using the systems and methods according to the present disclosure, a successful and operational interactive smart game plan would result or would be “outputted,” having capabilities as described herein.

The electronic mail component can be configured to deliver the growth initiative information to a salesperson at a pre-selected or predetermined time and date.

The method can further include utilizing an electronic analytics component to analyze the launch and execution process of the growth initiative and to provide indicators generated from usage and activity of the game plan.

The method can further include utilizing an electronic opportunity analyzer component to identify and prioritize prospects for the growth initiative.

The growth initiative information can be obtained from at least one database. This database can also be a relational database.

The electronic mail component can be configured to allow a growth initiative creator to input specific sales execution steps into the game plan and/or the electronic calendar component. The electronic mail component and/or the electronic calendar component can be configured to display the growth initiative information to a salesperson at a pre-selected or predetermined time and date.

The growth initiative information or the information relating to the growth initiative can include activities or events associated with a growth initiative. The activities or events can be generated electronically and automatically, and can be transferred to the electronic calendar component.

The growth initiative information or the information relating to the growth initiative can include prospect information and the prospect information can include a collection or a group of accounts or contacts for which a growth initiative is targeted.

Still, according to another aspect of the present disclosure, there is provided a method including a computer program product readable by a computer system having computer-executable instructions that when executed cause a processor of the computer system to generate one or more personal electronic mails in the execution of activities in an interactive smart game plan for one or more growth initiatives. The method can include sending one or more personalized electronic mail to one or more salespersons having growth initiative information personalized to the salesperson, pertaining to the growth initiative, wherein the growth initiative information includes at least one of sales execution instructions, prospect information, and prospect background information.

The method can further include displaying information relating to the growth initiative in an electronic calendar.

The electronic mail component can allow the salesperson to receive personalized training material for the growth initiative.

The information relating to the smart game plan and/or the information contained in the electronic mail can be sent or delivered via at least one of a world-wide web, a local area network and a wide area network.

The method can utilize one or more electronic input components configured to allow a growth initiative creator to input information and/or requirements for the growth initiative. This can be accomplished by utilizing an electronic initiative designer component to allow a growth initiative creator to at least one of, create, approve, and publish a growth initiative or display information for others to view once all of the information and/or requirements for the growth initiative have been inputted. The initiative designer component can include at least one database and at least one of, a product selection functionality, a segmentation functionality, an incentive functionality, a game plan functionality, and an analytics functionality. The database can be a relational database. However, modules other than this initiative designer can be used, as long as certain growth initiative information and requirements can be inputted. Upon utilizing such input component(s), and then additional information or requirements regarding the growth initiatives are added and implemented using the systems and methods according to the present disclosure, a successful and operational interactive smart game plan would result or “outputted,” having capabilities as described herein.

The electronic mail component can be configured to deliver the growth initiative information to a salesperson at a pre-selected or predetermined time and date.

The computer-executable instructions for the computer program product can further include utilizing an electronic analytics component to analyze the launch and execution process of the growth initiative and to provide indicators generated from usage and activity of the game plan.

The method can further include utilizing an electronic opportunity analyzer component to identify and prioritize prospects for the growth initiative.

The growth initiative information is obtained from at least one database. Again, the database can be a relational database.

The electronic mail component can be configured to allow a salesperson to input specific sales execution alternatives into the game plan and/or the electronic calendar component.

The electronic mail component and/or the electronic calendar component can be configured to display the growth initiative information to a salesperson at a pre-selected or predetermined time and date.

The growth initiative information or the information relating to the growth initiative can include activities or events associated with a growth initiative. The activities or events can be generated electronically and automatically, and can be transferred to the electronic calendar component.

The growth initiative information or the information relating to the growth initiative can include prospect information and the prospect information can include a collection or a group of accounts or contacts for which a growth initiative is targeted.

Other exemplary embodiments and advantages of the present invention may be ascertained by reviewing the present disclosure and the accompanying drawings.

### BRIEF DESCRIPTION OF THE DRAWINGS

This disclosure is further described in the detailed description which follows, in reference to the noted plurality of drawings by way of non-limiting examples of embodiments of the present disclosure, in which like reference numerals represent similar parts throughout the several views of the drawings, and wherein:

FIGS. 1-3 show display screens for an exemplary electronic input component utilized for the interactive smart game plan according to the present disclosure;

FIG. 4 shows a display screen of a smart electronic mail that can be generated by an automated electronic mail component according to the present disclosure;

FIGS. 5-8 show display screens for reviewing a growth initiative according to various embodiments of the present disclosure;

FIG. 9 shows a display screen that can be generated by the calendar component according to various embodiments of the present disclosure;

FIG. 10 shows a sample screen for an “Analytics” tab which allows the salesperson to see certain analytical information; and

FIG. 11 shows a sample home page or a starting reference to the interactive smart game plan according to the present disclosure.

### DETAILED DESCRIPTION OF THIS DISCLOSURE

The term “salesperson(s)” is used interchangeably with the term “user(s)” herein. The user and salesperson can include any user, i.e., someone who is not an active salesperson but directs a salesperson, or any business person that may or may not be actively involved in sales but is directly or indirectly involved in the daily or intermittent operation of a company. Thus, the salesperson or user can be anyone who can use the interactive game plan, method or system according to the present disclosure and can benefit from such, and the term “salesperson” is used in an exemplary purpose and not intended to be limited to any particular user. When referring to someone who is creating or designing the actual growth initiative, the term “user” is substituted with the term “growth initiative designer,” “designer” or “growth initiative creator.” As previously mentioned, the term “growth initiative creator” is commonly referred to in this situation for clarity. However, the usage of different terms when describing different users is not meant to limit the scope and breadth of the interactive smart game plan, systems and methods according to the present disclosure.

The term “interactive smart game plan,” “smart game plan,” “game plan,” and “plan” are used interchangeably herein. These terms can be used to describe the inventive methods and systems according to the present disclosure. They can include activities or events associated with a growth initiative. These activities can be system-generated activities that the salesperson needs to complete as part of the growth initiative.

The term “prospect(s)” is defined herein as a collection or a group of accounts or contacts (individual salespersons) for which a growth initiative is targeted. The prospect list can be derived from company owned customer/contact list, or the prospect list can be derived from the salesperson/contact list obtained elsewhere. Because of this, the salesperson can be independent of the company.

The term “growth initiative(s)” is defined herein as programs, events, and/or initiatives that help companies at least one of, create demand, add value throughout the sales channel, increase market share and drive revenue. The term “growth initiative(s)” is used interchangeably with the terms “initiatives,” “marketing initiatives,” “sales initiatives,” “marketing programs,” and “sales program.” The term “growth initiative(s)” can mean to include one or more of these initiatives or programs as understood in the industry. Thus, the term “growth initiative(s)” can include a sales initiative(s) which is a broad description defining proactive sales programs launched by the corporation to their sales channels. When effectively launched and executed, sales initiatives offer a great opportunity for both the company and sales channel to accelerate revenue.

Whereever the term “configured to” is used herein, it is meant that the interactive smart game plan, the system, the method and the computer-readable product according to the present disclosure are engineered or structured such that computer-readable instructions can be implemented to carry out specific tasks or display features as described. This term is not to be confused with the configuration systems or configuration computer programs otherwise known in the art pertaining to customizing manufactured products.

The interactive smart game plan according to the present disclosure provides the ability for enterprises to effectively execute growth initiatives through their sales channels.

The interactive smart game plan can vary in scope depending on the type of growth initiative. For example, a product announcement can use a more extensive interactive smart game plan than one that is for merely a simple sales promotion. A key element of the interactive smart game plan is its process organization and action-orientation.

According to one or more embodiments of the disclosure, tools, resources and/or other aids are displayed and/or sent to the salespersons at the appropriate time in the process. This approach has two effects: first the salespersons are guided through a process based on proven practices to maximize results, and second, the right tools and resources are displayed and/or sent to the salesperson at the appropriate time. This prevents the salesperson from being required to search for information and tools during the sales process. The salesperson's electronic mail and/or calendar system that are connected to the smart interactive game plan can be displayed and/or sent, which therefore can relate to the tools and content that are specific to each customer/prospect for each growth initiative. Thus, the interactive electronic mail and calendar within the smart interactive game plan are dynamically generated. This capability improves the execution of the growth initiative by the salesperson.

The game plan can be role based. In many sales environments, the roles and responsibilities are divided between sales, field sales, sales management and sales support personnel. The game plan can allow the sales team to work together to accelerate sales and execution, in a more efficient manner, with respect to the growth initiative.

The game plan can be flexible and vary in scope such that a company can be involved in creating the game plan geared more towards its needs, i.e., the company can implement its needs in the growth initiative. For example, the company can model best practices of its top sales performers and include those practices in the game plan. This enables all salespersons to take advantage of these best practices and apply them to their specific sales situations. Companies can benefit from this approach as it creates a disciplined approach to the selling process and ultimately enables opportunities to be won or completed.

Based on these best practices, the interactive smart game plan can be configured or developed as an internet-based product to help companies launch new growth initiatives more effectively and at a reduced cost to their sales channels. The following are examples of the best practices that can be integrated into the interactive smart game plan:

a. Focus continually into the future of the sales processes and the ability to consistently execute, measure and improve them over time;

b. Launch growth initiatives like new products, sales campaigns, and new markets that can propel an organization forward, while leveraging the opportunities created by these key events;

c. Envision the future to include both corporate sales and independent sales channels;

d. Segment the customers by helping the salesperson to sell to the preferred prospects;

e. Draw the products and services to the customers rather than waiting for prospects to come to the dealer;

f. Help the salesperson consistently communicate “the story” or pertinent information to prospects;

g. Monitor analytics in real-time to measure plan execution, making mid-course corrections as needed while gathering the data for this with a minimal amount of work by the salesperson so that what can be measured can be improved;

h. Integrate training into both the corporate and channel salesperson's daily work in a continuous learning approach in order to yield increased competency and higher adoption;

i. Implement a system for clear, rapid communication throughout the sales organization;

j. Offer valued tools and information for use by customers and prospects in order to help build relationships and influence future purchasing decisions; and

k. Ensure that the best practices are put into use while being flexible enough to allow best practices to change over time; and ensure that an effective solution must be able to integrate and support the changes.

Of course, other best practices that the interactive smart game plan can implement, are possible.

The game plan can prioritize many sales activities and growth initiatives for the salesperson. The ability to prioritize prospects, sales activities and commitments that need to be performed when a salesperson may have, for example, 20 sales promotions, 2 product announcements plus 2 channel partners generated sales promotions running concurrently, is made easier and more effective when they are converged into a salesperson specific game plan.

With the interactive game plan according to the present disclosure, one can leverage the sales tools and resources already invested by the enterprise. The game plans are a way for companies to put growth initiatives to work and grow revenue. The process structure also helps the salesperson to execute multiple initiatives and to implement processes used by the most effective salespeople. This helps the average salesperson to perform and obtain the best potential because of the game plan's:
1) ability to deploy actionable growth initiatives;
2) ability to converge tools and resources in a process that is more effective by pushing the appropriate tool and content to the salesperson, improving the salesperson's adoption and acceptance;
3) ability to help the salesperson leverage the resources and people around him or her; and
4) ability to combine all of the growth initiatives in a way where they are more effectively executed.

The game plan can include built-in analytic capabilities that provide management visibility into the progress of the launch and execution process. These analytics can provide leading indicators and can be generated from usage and activity rather than forms based on reporting.

The game plan can be flexible such that it can be part of a suite of products. Along with the game plan, other modules that can be implemented in the suite of products can include:
1) an input component such as an initiative designer that provides the ability to create, build, approve, and publish growth initiatives (such as the initiative designer according to the disclosure of U.S. patent application titled “Initiative Designer,” filed concurrently herewith, having Attorney Docket No. P68370; and
2) an opportunity analyzer that provides the ability to identify and prioritize the good, better, and best prospects for a growth initiative.

An optimal input component or initiative designer that can be utilized can have the following functions and components. The initiative designer can have at least one of, a product selection functionality, a segmentation functionality, an incentive functionality, a game plan functionality, and an analytics functionality. The initiative designer can utilize one or more database. Preferably, the database is a relational database. Such relational databases that can be utilized or implemented are available or supplied by companies such as MICROSOFT®, ORACLE®, TERRADATA™, etc. An example of a product from MICROSOFT® that can be utilized is MICROSOFT®'s MYSQL® technology. It is to be understood that the initiative designer and the opportunity analyzer are optional components and are not required for the interactive smart game plan, systems or methods according to the present invention. An input component such as the initiative designer is utilized as a starting point for the interactive smart game plan. Certain information and requirements of the growth initiatives are inputted via the use of this particular input component or initiative designer. Other input components can be used to input other information and requirements for the game plan and are not to be confused with this input component and initiative designer.

The game plan can be implemented to operate on the web, i.e., the internet, or any other mode of communication known in the art, and can be implemented as a software-as-a-service or in an enterprise-level suite of application.

A preferred interactive game plan according to the present disclosure can have at least the following functionalities or components. The interactive smart game plan can have or utilize one or more databases, which can be separate from the databases of the initiative designer. Preferably, the database is also a relational database. Such relational databases that can be utilized or implemented are available or supplied by companies such as MICROSOFT®, ORACLE®, TERRADATA™, etc. An example of a product from MICROSOFT® that can be utilized is MICROSOFT®'s MYSQL® technology. The interactive smart game plan can have one or more electronic mail and/or calendar systems. Such electronic mail and/or calendar systems that can be utilized or implemented are available or supplied by companies such as MICROSOFT®, GOOGLE®, YAHOO®, EXACTTARGET® and IBM®. The technology of these systems allows the game plan activities to be communicated to the salesperson.

For example, EXACTTARGET® is a product and/or service available from EXACTTARGET® that allows client specific sub-sites and a simple programmatic interface for e-mails. This product/service can be integrated with the interactive smart game plan according to the present disclosure to create client accounts within the accounts of the smart game plan and/or user logins for clients (i.e., users, marketing initiative creators, or salespersons). Clients can be setup to see their own e-mail data within the EXACTTARGET® product/service but not the data of any other clients and each of these client “sub-sites” can be branded with the interactive smart game plan's look and feel (color scheme and logo) or with their own brand(s). Additionally, user accounts can be set up as a per sub-site with various permission levels being available. Creation and administration of these sites can be a manual process that will require personnel but it should be a short set-up time per customer with minimal ongoing administration.

The application programming interface (API) provided by EXACTTARGET® can include commands, formatted in xml that are transmitted to EXACTTARGET® via HTTPS called ETXML. However, a web services interface, ETWS, can also be implemented. The ETXML interface can be used to handle the tasks of creating and administering lists, subscribers, mailings, and tracking data. Using this API, the smart interactive game plan according to the present disclosure can automate the exporting/updating of customer data from the end client to EXACTTARGET®, creating mailing lists and groups within those lists, thereby sending mailings and retrieving tracking summaries transparently to the user. The EXACTTARGET® website also has a developer portal that contains useful code samples and looks to offer good support for use of the API, both from other developers and from EXACTTARGET® technical staff.

Another task that can be implemented within the smart game plan is the creation of the e-mail content itself. While the API does allow for sending e-mail content for creation of a mailing, it does not provide an ability to create the content as it is really a command delivery system rather than a creative tool. The EXACTTARGET® client site can provide some rich content creation tools that can be integrated into the smart game plan. This content creation feature can allow “content-syndication,” which is the injection of content from the client's site into EXACTTARGET® created e-mails. Using this tool can involve transferring the users to their sub-site at EXACTTARGET® for the e-mail creation and retrieving control when they are done, or possibly just offering a link within the application to allow the client to create e-mails “off-line.” E-mail content created from the EXACTTARGET® site is visible from the API and can then be used as the content for an automated e-mailing. Thus, the product/service available from EXACTTARGET® can be integrated into the smart game plan to provide tools and site branding (or client customization). Other communication technologies available in the industry can be utilized and implemented.

The databases, including the relational databases, can be any of the databases described in disclosure titled “Initiative Designer” as referred to above.

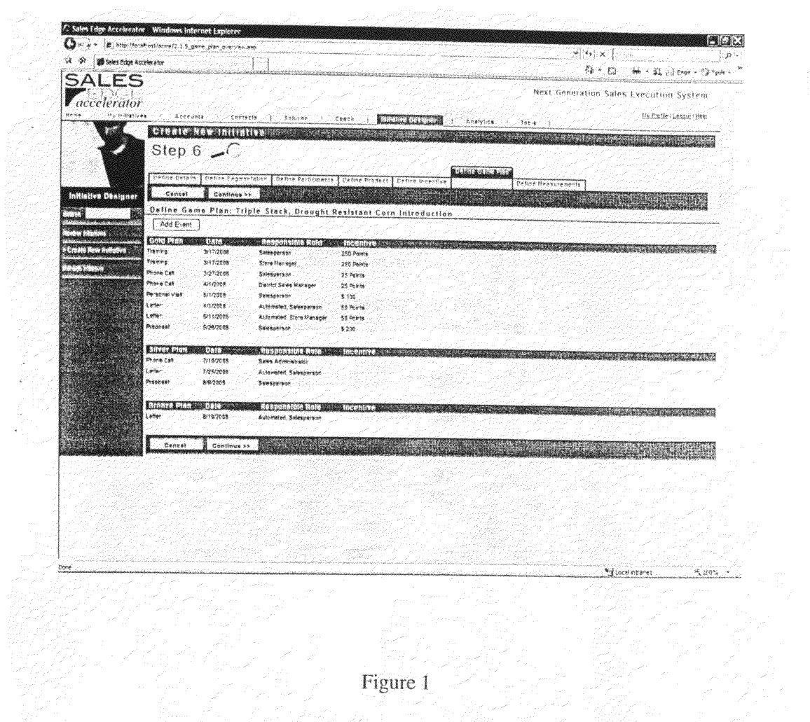

FIGS. 1-3 show display screens for an exemplary input component utilized for the interactive smart game plan according to the present disclosure. The input component determines what activities will be required or suggested as part of the sales process.

An input component would provide the ability to create, build, approve, and publish growth initiatives. An exemplary input component is the initiative designer according to the above-mentioned disclosure of U.S. patent application titled “Initiative Designer,” filed concurrently herewith, having Attorney Docket No. P68370. It is to be understood that the initiative designer and any particular input component is optional for the interactive smart game plan, systems and methods according to the present disclosure. They are a starting point for the smart game plan. This input component or initiative designer is not to be confused with other input components that are needed for the interactive smart game plan, systems and methods according to the present disclosure. This input component or initiative designer can be viewed as the “input” and the interactive smart game plan, systems and methods according to the present disclosure as the “output” of a successful and operational interactive smart game plan with respect to the growth initiative. Other input components can be used or an input component such as the initiative designer is not needed at all for the interactive smart game plan, systems and methods according to the present disclosure. For example, if the growth initiative is simple, such that there are not many complex information, rules and requirements are required for the growth initiative, the interactive smart game plan, systems and methods according to the present disclosure can operate by itself without these optional components. Information pertaining to the growth initiative can be entered manually and interactive smart game plan, systems and methods according to the present disclosure is still valuable for the salesperson since they can obtain the many benefits described throughout this disclosure.

Thus, FIG. 1 shows a game plan that is being created utilizing an optional input component, such as an initiative designer, as a starting point. Therefore, “Step 6” is shown at the top of FIG. 1 (Steps 1-5 (not shown) can be viewed as the steps utilizing an input component such as an initiative designer to design, input information for, or set up requirements for a particular growth initiative). As a result, if one were to use an input component such as an initiative designer as a starting point, steps 1-5 would be required. Otherwise, Step 6 is the starting point as is depicted in this example.

FIG. 1 shows that the game plan is being defined or has been defined by virtue of the tab “Define Game Plan” which is located at the top of the screen and the caption “Create New Initiative” which is located on the left side of the screen.

In this example, during or after the process of defining the game plan, three market segments for the game plan are established, which are listed as the Gold Plan for a first market segment, the Silver Plan for a second market segment and the Bronze Plan for the third market segment. On this screen, the person responsible is displayed under “Responsible Role” for each of the market segments. The Gold Plan is the most sought after, then the Silver Plan, and then the Bronze Plan. In this example, for each of the market segments, a responsible person is already determined, along with an established training date, a phone call date, a personal visit date, a date for sending a letter, and a proposal finishing date for each of the responsible person. Also shown are different incentives that were defined for different activities or events.

As can be seen in the screen shot of FIG. 1, the interactive smart game plan can operate as a web-based application. Thus, all of the features of WINDOWS INTERNET EXPLORER® and GOOGLE® can be utilized as are well-known and are not discussed herein.

In this example, the game plan is defined for a growth initiative titled as “Triple, Stack, Drought Resistant Corn” and the “Introduction” caption indicates that the information shown is certain information that is considered basic with respect to this particular growth initiative.

In this “Create New Initiative” screen shot, seven self-explanatory tabs are shown that can assist the salesperson: Define Details, Define Segmentation, Define Participants, Define Product, Define Incentive, Define Game Plan, and Define Measurements. Another layer of self explanatory tabs that can assist the growth initiative creator in utilizing the interactive smart game plan are shown: Home, My Initiatives, Accounts, Contacts, Solution, Coach, Initiative Designer, Analytics and Tools. Other tabs are possible.

On the left hand side of the screen is a menu that can assist the growth initiative creator in navigating from one screen to another, as further described below. Other features shown on this screen that are common with other screens are further described below. However, different formats, different menus, different tabs, different buttons are possible.

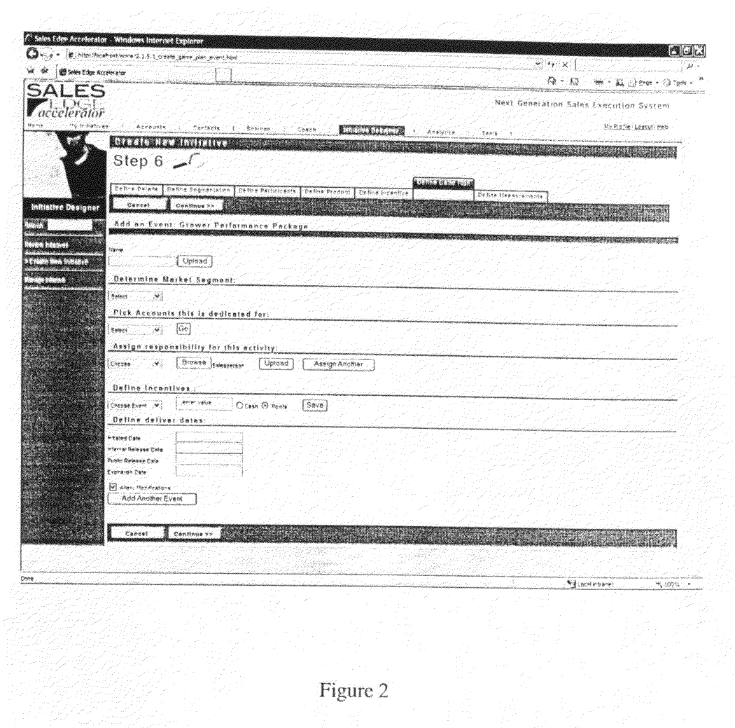

The “Add Event” button near the top of the screen allows a growth initiative creator to add a new event for the game plan, as further shown in FIG. 2. At the bottom of the screen, two buttons are displayed to allow the growth initiative creator to cancel or continue with the process of defining the game plan for the growth initiative.

When the growth initiative creator hits the “Add Event” button in the screen shown in FIG. 1, the growth initiative creator is taken to the screen shown in FIG. 2. At the top of this screen, the growth initiative creator can name a new event in the “Name” box or pull up an existing event by putting in the name and then hitting the “Upload” button.

Next, the market segment can be determined. Following the example provided in FIG. 1, when the growth initiative creator hits the “Select” button in this category, three possible choices are presented for selection: Gold, Silver and Bronze.

In the next section below, the growth initiative creator can assign the responsibility of an event or activity to a particular role or person (or group). In this section, when the growth initiative creator hits the “Browse” button, he or she can select a named individual for an intended role. The names can be selected from a list (not shown). For example, names can be selected from a list titled “Account List,” “Contact List” or “Groups.” The “Assign Another” button allows the growth initiative creator to assign the activity to another person or group, and thus to more than one person or group.

In the next section, the incentives can be defined for the particular event that is defined or chosen, the value of the incentive, whether cash or points are involved, and a “Save” button allows the growth initiative creator to save the selections.

In the next section, the growth initiative creator can define the delivery dates for the event. For example, an initiated date, an internal release date, a public release date and an expiration date can be entered.

The growth initiative creator has the option of allowing modifications to the event being characterized, post the task or event as a main page task (not shown), and of course, add another event. Other specifics for defining the event or incentives can be utilized.

The top buttons on this page (and other pages) can again include the “Back” button or “Forward” buttons (shown by the forward arrow and back arrow button, respectively), as are commonly known for WINDOWS INTERNET EXPLORER®, while a “Save Data” button (not shown) and the “Continue” button (as shown in the previous page) can be utilized in any screen.

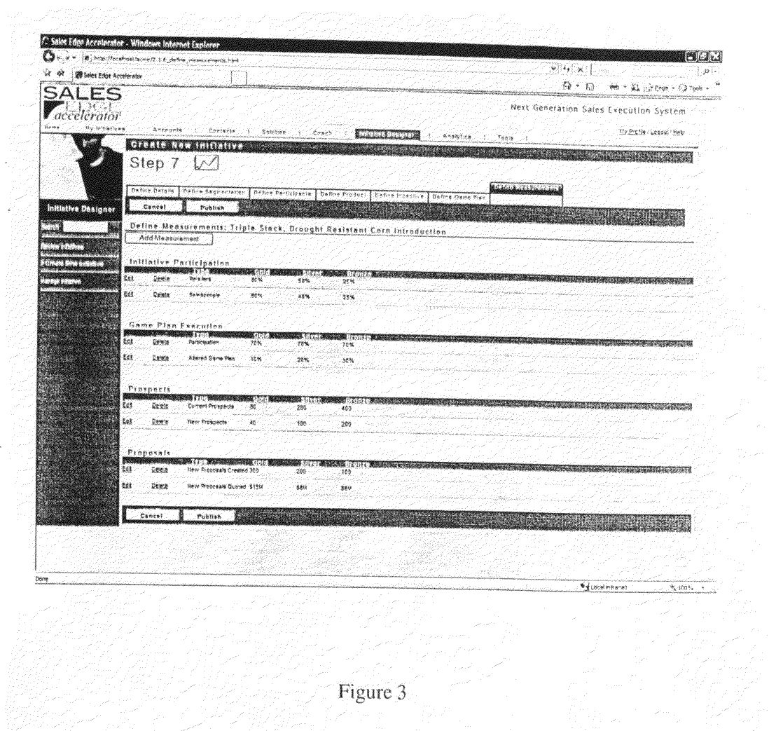

On the screen shown in FIG. 3, the growth initiative creator has the option of publishing the growth initiative for others to see when all required information about the growth initiative has been inputted. Here, the growth initiative creator can see the four subsections that are labeled as “Initiative Participation,” Game Plan Execution,” “Prospects” and “Proposals.” Other subsections are possible. Listed are the types of growth initiative participation (such as retailers and salespersons), the types of game plan execution (such as participation and altered game plan), the types of prospects (such as current prospects and new prospects), and the types of proposals (such as new proposals created and new proposals quoted). Other types are possible. For each type, the established percentages, values or monetary amounts are listed. Each type can be easily edited or deleted by hitting the respective buttons as shown. This screen is how a growth initiative creator can define the measurement of the growth initiatives and can be accessed via the “Define Measurement” tab as shown.

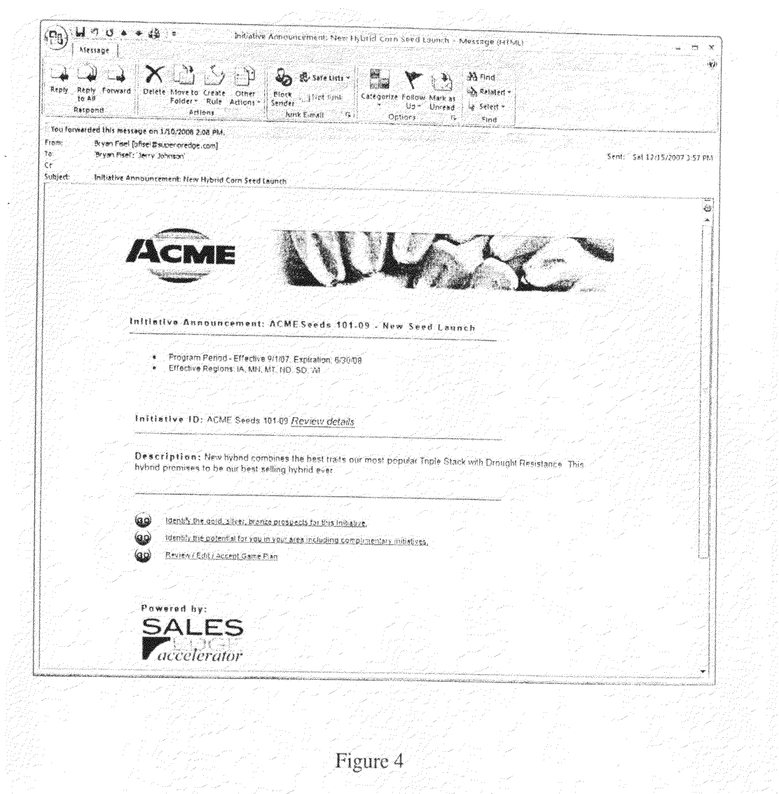

When the growth initiative creator pushes the “Publish” button in the screen shown in FIG. 3, the growth initiative is “published” or posted for others to see, an example of which is shown in FIG. 4. The system according to the present disclosure automatically generates the smart electronic mail for a salesperson containing the information required to execute the growth initiative, as well as links to any required sales tools the salesperson would need during the execution of the growth initiative.

A smart electronic mail (e-mail) example with these features that can be generated is shown in FIG. 4. At the top of the e-mail, the product and growth initiative are identified. One or more items of information can be listed. For example, as shown in this electronic mail example, the product's/growth initiative's information includes key strengths, weaknesses, management recommendations, and positioning within a current line-up.

In the smart electronic mail, a growth initiative identification number can be provided for reference purposes, and a link labeled as “Review details” can be provided for the salesperson to see additional information about the growth initiative.

A basic information/description section can be provided.

Following this basic information, action buttons are provided to assist the salesperson to execute the growth initiative. Three “Go” buttons are shown in the example shown in FIG. 4:
1) Identify the gold, silver and bronze prospects for this product;
2) Identify the salesperson's potential in his or her area including complimentary growth initiatives; and
3) Review/Edit/Accept Game Plan.

These buttons launch the execution steps as identified. Other buttons for other tasks that can assist the salesperson to execute the growth initiative are possible.

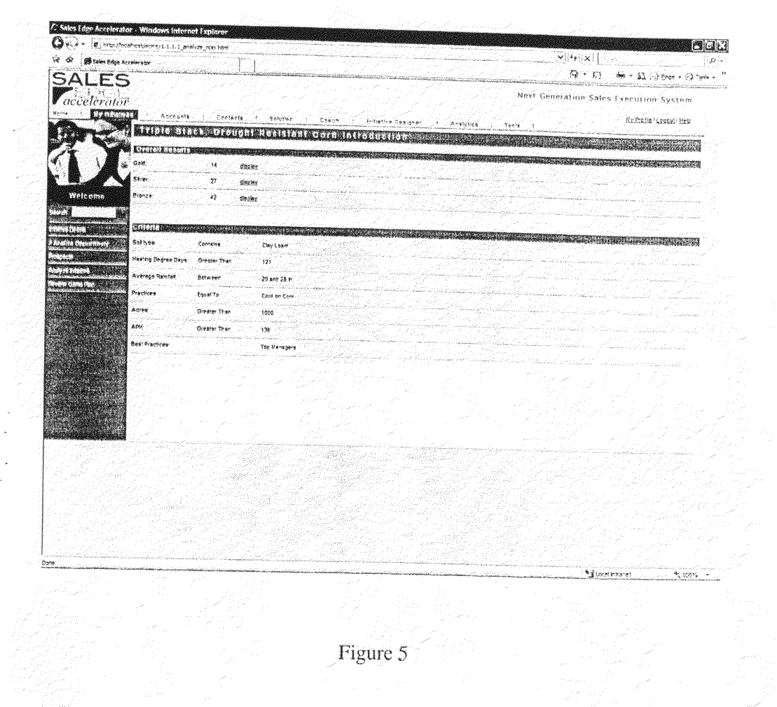

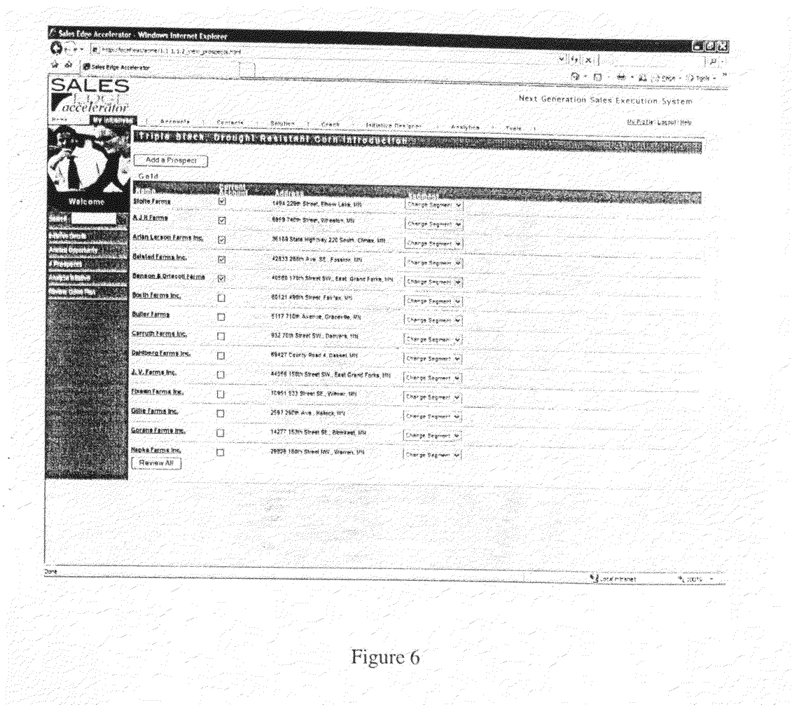

FIG. 5 shows how a salesperson can access his or her prospect information for a specific growth initiative. The salesperson can access information about the growth initiatives like what the potential commission or incentives would be for the growth initiative. In the example shown in FIG. 5, there are three numerical values established for three different plans or market segments, such as Gold, Silver and Bronze. A “display” button allows the salesperson to see additional details. For example, the display button can provide the salesperson the actual prospect information associated with each segment. In this example, as shown in FIG. 5, there are 14 gold prospects. By selecting the display button, the salesperson can actually see details about who the prospects are (i.e., the display button in FIG. 5, takes the salesperson to the screen shown in FIG. 6). A “Criteria” section in the screen shown can allow the salesperson to view what the criteria are that were used to search the database(s) in order to determine the gold, silver, and bronze prospects. For example, if the salesperson wants to know why or how a prospect was classified as gold, this screen shows what the criteria was used to search the database(s) of prospects to determine which ones best met the defined criteria. (Information that is actually part of the criteria used to search the database (while not shown in the figures, but can be optionally displayed on any screen as desired), can be, but is not limited to: the product that is being sold and any specific information about the product; information about best practices; usage; loyalty/supplier preference; future potential; and demographics.)

At the top of this screen (and other screens), three buttons are shown that allow the salesperson to view his or her profile, log out or obtain help. These buttons can be added to any screen that displays information about the growth initiative once the salesperson has logged in and viewed any information.

In FIG. 6, prospect information is displayed under the “My Initiatives” tab. In this example, the prospect information is shown for the gold segment. The names of the prospects are shown, an indicator is shown whether the prospect is a current account, the addresses of the prospects are shown, and an option is allotted to change the segment for each prospect. A button is shown for adding another prospect to the list and a button is shown for reviewing all of the prospects.

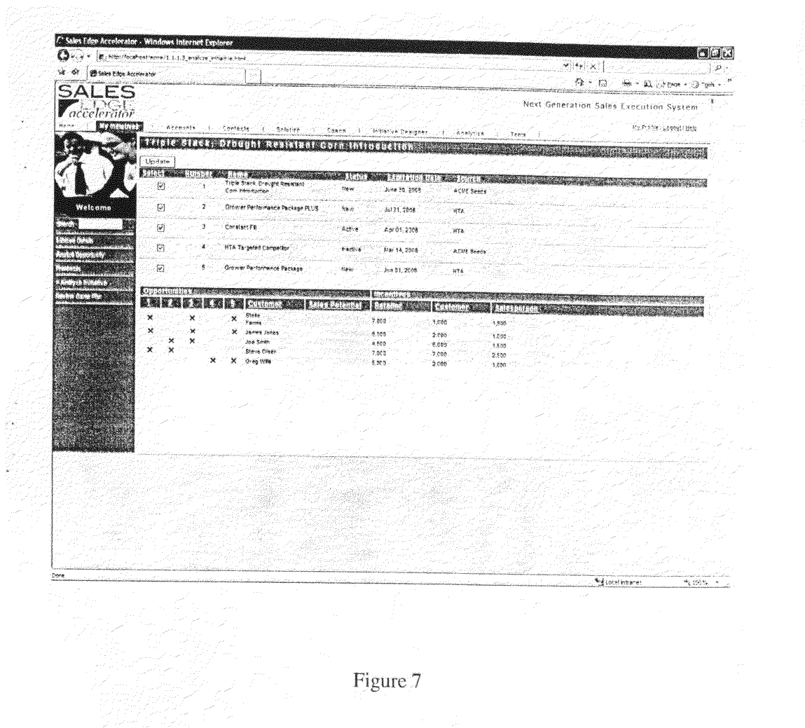

In FIG. 7, a screen is shown that allows the salesperson to review or analyze a specific growth initiative. In this example, five growth initiatives are shown, that are numbered sequentially. For each growth initiative, the name of the growth initiative, the status of the growth initiative (new, active or inactive), the expiration date, and the source for the growth initiative are shown. Additionally, for each growth initiative shown, a “Select” button allows the salesperson to indicate whether or not the growth initiative will be included in the analysis section below in the screen. For example, if the salesperson unselected growth initiative number 4, then below in the analysis section, the “X” in column number 4 would be removed and the incentives associated with growth initiative number 4 (grower performance package) would not be included in the analysis.

Other information can be displayed in this screen. For example, in FIG. 7, the opportunities and incentives information are displayed. For opportunities, the names of the companies or individuals of customers or possible customers can be displayed. For each customer's name, an indication can be provided to show the growth initiative to which the particular customer is applicable. For incentives, an amount of points or a value (such as a monetary amount) that is determined by the growth initiative creator, is displayed for each customer. For example, a monetary amount can be established for incentives for a retailer, a customer and a salesperson for a particular sale. For example, the first customer or potential customer shown in FIG. 7 is Stolte Farms. This customer can be an opportunity for initiatives numbered 1, 3 and 5, which are identified in the top portion of the screen. For this opportunity, the established value of incentives for the retailer, the customer and salesperson are 7,000, 1,000 and 1,500, respectively.

Since at the top of the screen, a salesperson has selected all five of the displayed growth initiatives (where the check mark is shown in the “Selected” button), all of the opportunities and incentives information applicable for the five growth initiatives are displayed at the bottom of the screen. In this particular example, four other customers' information are displayed in a similar manner as that of the first shown customer, Stolte Farms.

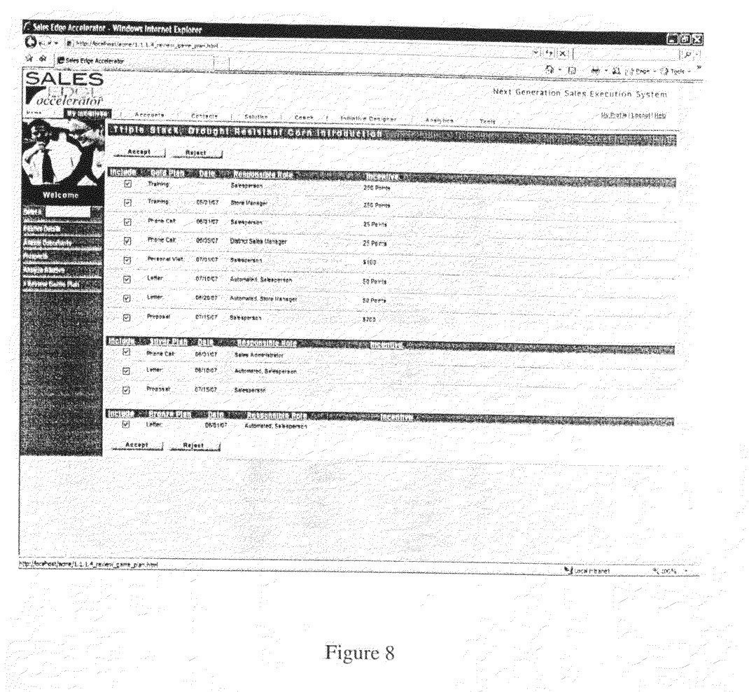

FIG. 8 shows an example screen where a salesperson can view the recommended sales execution steps based on best practices. Thus, this screen provides details about the game plan for the salesperson to review and steps for the salesperson to execute.

In this example, the activities that need to be executed for the gold plan, the silver plan and the bronze plan are shown for the game plan of a particular growth initiative. These activities can include, but are not limited to, training, phone calls, personal visits, letters and proposals. For each activity, the date of execution and the responsible role or the person responsible for the activity are displayed. The responsible role can be, but is not limited to, a salesperson, a store manager, a district sales manager, and a sales administrator. Certain activities can be automated and displayed as such. For example, a letter that needs to be sent to or from a salesperson can be automated. An “Include” button, as shown in the figure, can allow the salesperson to select which activity to be included, executed, or displayed for each activity. Other listed activities and roles are possible. A “Reject” button and an “Accept” button allows the salesperson to reject or accept the game plan, respectively.

On the left side of the screen, different buttons and menus can be provided to assist the salesperson. These buttons can show optional features. For example, a menu for reviewing the growth initiative is shown, which includes, but is not limited to, initiative details, analyze opportunity, prospects, analyze initiative and review game plan. By clicking on the link to “Initiative Detail,” the salesperson can view information for a particular growth initiative. The “Analyze Opportunity” link takes the salesperson to the screen such as the one shown in FIG. 7. The “Analyze Initiative” link takes the salesperson to the screen in FIG. 7. By hitting the link to “Game Plan,” the salesperson is directed to a screen such as the one shown in FIG. 8.

A “Search” box and “Go” button in this section of the screen allow the salesperson to enter a word, phrase, document information or any information that is of interest with respect to the growth initiative or game plan, and obtain information.

As indicated previously, multiple tabs can be utilized to guide the salesperson.

An “Accounts” tab allows the salesperson to view all accounts that have been assigned to the salesperson or that have been created by the salesperson. For example, this tab can take the salesperson to a screen (not shown in the present figures) to view all accounts assigned to the salesperson that is not segmented by any growth initiative.

A “Solution” tab allows the salesperson to create solutions (such as a combination of products and services that the salesperson is offering to a particular prospect). For example, by using this tab, the salesperson can see a screen where the salesperson has created solutions for Stolte Farms in different years (not shown in the present figures).

A “Coach” tab allows the salesperson to access any training or coaching tools, content, vignettes, training information, etc. For example, by use of this tab, the salesperson can see that he or she could work through a training piece on a new product prior to going out to visit a particular prospect that has been identified as a candidate for this product via the segmentation that is established by the growth initiative creator (not shown in the present figures). An example screen can show the following information:

“The following series of four steps will:

1) From a customer perspective, define their needs.

2) Prioritize the needs of the customer.

3) Match features to the needs of the customer.

4) Create a presentation, matching needs of the customers and the products.

Throughout the steps, your responses will be recorded and compared to the correct answers. The results will be presented following the completion of step four. We estimate this scenario will take fifteen minutes to complete.”

Other coaching needs for the salesperson can be presented.

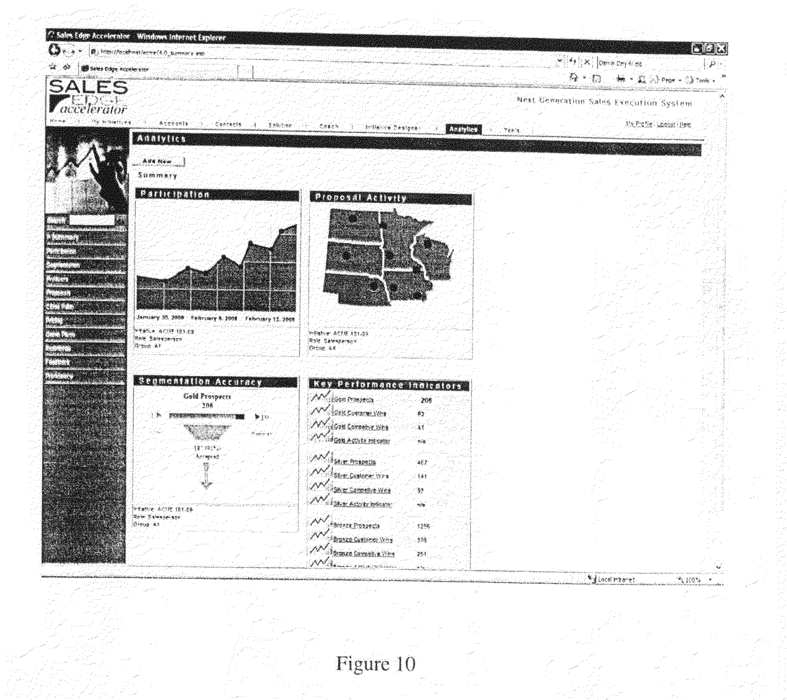

An “Analytics” tab allows the salesperson to see certain analytical information. For example, by accessing this tab, only authorized users or salespersons (wider authorization can be determined by the growth initiative creator) can access analytical information associated with the growth initiatives. Typically, only the growth initiative creator or someone in management would have access to view this screen. The analytics provide information on how the initiative is performing against the metrics established in the initiative designer. Example information can include, but not limited to: participation of salesperson for a particular growth initiative for a particular time frame; a regional map (i.e., Midwestern states) showing proposal activity by salespersons for a particular growth initiative; segmentation accuracy for a particular prospect for salespersons for a particular growth initiative; and key performance indicators. An example screen for this is shown in FIG. 10.

A “Tools” tab can provide authorized users the ability to set up user requirements, assign the users a role, and assign the user to a group. For example, it can allow the authorized user to create hierarchy of users (i.e., salesperson who reports to a sales manager, who in turns reports to a district sales manager, who in turns reports to the vice president of sales, etc.) (not shown in the present figures). Each user can be assigned a role. A role can have certain authorizations and access restrictions can be established. The tools tab can traditionally be used by a system administrator, or the like.

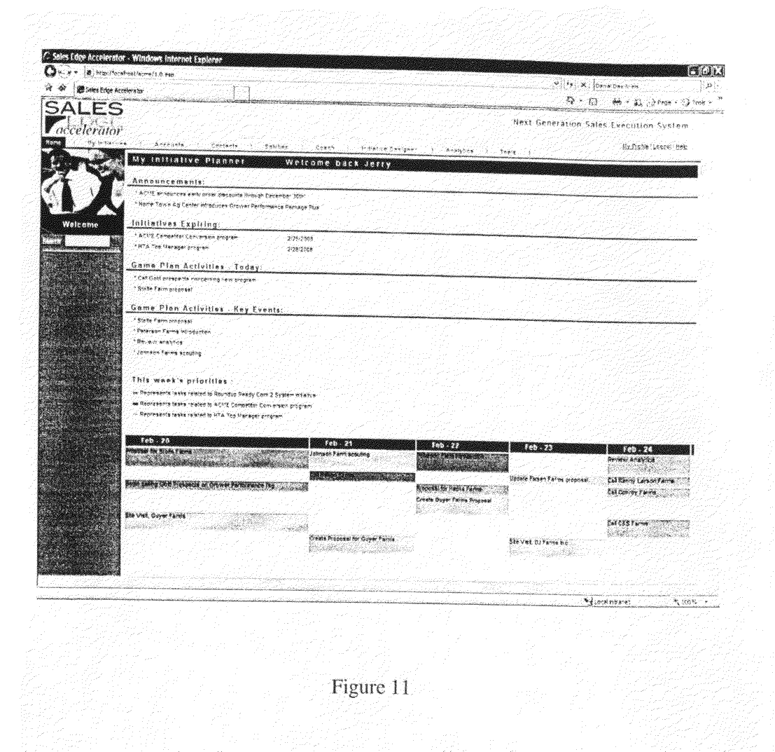

Other tabs or buttons are possible, such as the “Home” tab shown in FIGS. 1-8. The “Home” tab allows the salesperson or other authorized users with a home page or a starting reference to the interactive smart game plan according to the present disclosure. This page (shown in FIG. 11) can show announcements, calendar of events, etc. Other desirable information that can be shown is possible. Another possible tab that is shown in the present figures is the “Contacts” tab. This tab can allow the salesperson to view all contacts that have been assigned to the salesperson or that have been created by the salesperson. Contacts may or may not be associated to an account. A possible screen that the salesperson is taken to when the “Contacts” tab is hit, can show all contacts that are assigned to the salesperson but are not segmented by any growth initiatives (not shown in the present figures). However, other information and form of display for this screen are possible.

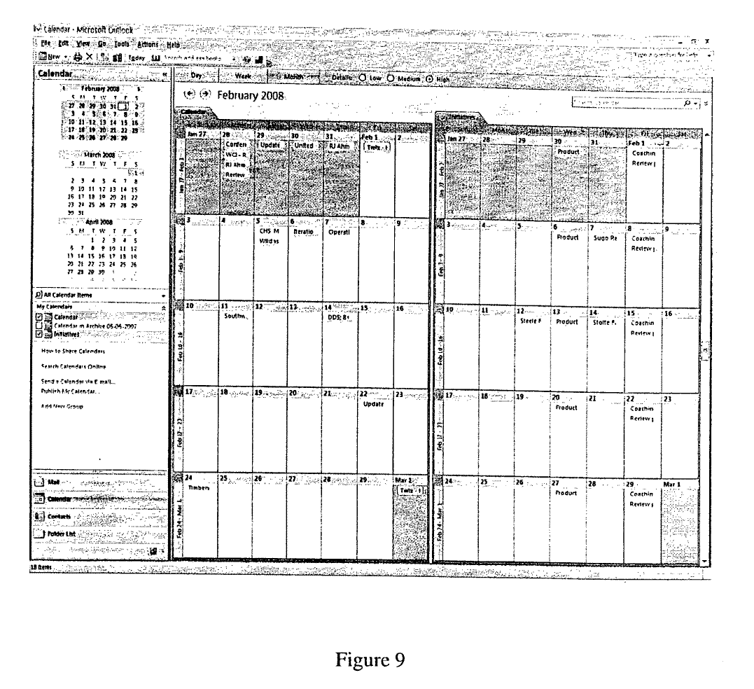

FIG. 9 shows a screen that the salesperson sees when viewing his or her calendar, which can be provided by the automation of the interactive electronic mail/calendar component of the interactive game plan of the present disclosure. Activities can be listed for each calendar day and organized based on the automation. Various types of organization and details listed on the calendar are possible. A top menu and a number of buttons on the side of the screen can assist the salesperson as shown. For example, different buttons, are possible, such as “How to Share Calendars,” “Search Calendar On-line,” “Send a Calendar via E-mail,” “Publish My Calendar,” and “Add New Group.” In this example, MICROSOFT OUTLOOK® calendar system is utilized. Features of this system can be readily implemented in the interactive game plan, systems and methods according to the present disclosure. However, other features of other 3^{rd} party applications can be utilized and implemented.

Thus, the interactive smart game plan according to the present disclosure allows a salesperson to utilize information provided and to proactively execute steps which can be presented to the salesperson by the automation of the game plan in order to launch a personalized growth initiative that is based on his or her needs and abilities. The methods' and systems' unique approach is how they connect the sales execution steps of the growth initiative to each specific salesperson. This interactive smart game plan pushes to the salesperson all of the prospects, content and required sales tools at the appropriate time in the sales cycle to the salesperson via his or her e-mail and calendar. Thus, the salesperson does not need to search for the content or tools during the sales campaign.

Embodiments of the present disclosure may be applied in the context of a computer system. The system can include a conventional personal computer, including a processing unit, a system memory and a system bus that couples the system memory to the processing unit. System memory includes read only memory (ROM) and random access memory (RAM). A basic input/output system (BIOS) containing the basic routines that help to transfer information between elements within the personal computer, is stored in the ROM.

Embodiments of the present invention can be applied in the context of computer systems other than the personal computer. These computer systems can include handheld and/or wireless devices (such as, but not limited to, wireless PDA (personal digital assistant) cell phones, PALM PILOT® devices, other PDA devices, and the like), multiprocessor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present disclosure may be accomplished utilizing either local or remote storage devices, or simultaneously utilizing both local and remote storage devices.

The personal computer can further include a hard disc drive, a magnetic disc drive, and an optical disc drive. A magnetic disc drive can be utilized to read from or to write to a removable disc. An optical disc drive can be utilized for reading data from (or writing data to) an optical media, such as a CD-ROM disc. The hard disc drive, magnetic disc drive and optical disc drive can be connected to the system bus by a hard disc drive interface, a magnetic disc drive interface, and an optical disc drive interface, respectively. The drives and their associated computer-readable media can provide nonvolatile storage for the personal computer. Other types of media that are readable by a computer may also be used in the operation environment.

A number of program modules can be stored in the drives and the RAM, including an operating system, one or more application programs, other program modules and program data. In particular, one of the other programs modules can be any of the components described above that demonstrate certain features and embodiments of the present disclosure.

Input devices can include a keyboard and a mouse (or other pointing devices) and can be operably connected to the system bus through a serial port interface that is coupled to the system bus. Input devices could be connected utilizing other interfaces such as a universal serial bus (USB). A monitor can be connected to the system bus through a video adapter. Other peripheral output devices (e.g., speakers or printers) can also be included. Other configurations of the system than those described above are possible.

The systems and methods according to the present disclosure can be implemented such that it can be functional via a world-wide web, a local area network or a wide area network. Accordingly, a computer program product readable by a computer system having computer-executable instructions that when executed cause a processor of the computer system to generate one or more of the personal electronic mails in the execution of activities in an interactive smart game plan for one or more growth initiatives can be utilized for the systems and methods according to the present disclosure.

For example, the personal computer can operate in a network environment utilizing connections to one or more remote computers. The remote computer can be a server, a router, a peer device, or other common network nodes. The remote computer can include many or all of the features and elements described in relation to any personal computer. The network connections can include a local area network (LAN) and/or a wide area network (WAN).

For example, the personal computer can be connected to the LAN through a network interface. The personal computer can also be connected to the WAN and can include a modem for establishing communications over the WAN. The modem, which can be internal or external, and can be connected to the system bus via the serial port interface. However, any other methods of communications that are different from a modem and are available in the art can be used.

In a networked environment, program modules relating to one or more computer readable products containing one or more components of the interactive smart game plan, or portions thereof, can be stored in a remote memory storage device. For example, application programs can be stored utilizing a memory storage device that carry instructions to execute according to the smart game plan or that demonstrates certain features and embodiments of the present disclosure. It will be appreciated that the network connections described above are exemplary and other methods for establishing a communications link between the computers, such as a wireless interface communications link, can be used.

Notwithstanding the broad applicability of the principles of the disclosure described above, it should be understood that the configuration of the exemplary embodiments as an application program that is stored on, and enables data to be stored on, a remote computer provides significant advantages although the systems, methods and computer readable products as described above, already provide significant advantages in assisting a salesperson to directly connect the growth initiative to the sales and the execution of the growth initiative.

Thus, the interactive smart game plan, methods, systems and computer readable program product according to the present disclosure provide a wide array of benefits. They allow a salesperson not only to focus on launching products to sales channels, but also to launch sales campaigns targeted at a particular market segment, launch existing products into new markets, and lunch new channel organizations and territories. They also allow the salesperson to expand his or her focus to include the launch of a wide variety of initiatives as described. Thus, the methods and products according to the present disclosure allow the salesperson to launch these initiatives in a meaningful way. One way that this is accomplished according to the present disclosure is by having dealers, agents, resellers and direct salespeople as an integral part of the program. The smart interactive game plan according to the present disclosure is configured to utilize all of these players. In doing so, the growth initiative not only can generate revenue but can also provide secondary benefits, such as, creating a stronger channel network and developing a greater channel mindshare and loyalty.

The products and methods according to the present disclosure can help a salesperson perform a specific task by leveraging the internet and launching growth initiatives with an enterprise in mind. This can be accomplished in several ways. One way is by converging internet-based sales tools. The inventive products and methods integrate tools, content, expertise and processes to successfully launch growth initiatives such as, but not limited to, new products, new channels, sales campaigns, and promotions throughout a dispersed sales network.

Thus, the importance of independent sales channels is recognized. The importance of best practices in launching the growth initiative is also recognized and implemented by the inventive system and product as described.

As a result, the present disclosure can allow a salesperson to obtain solutions to enable the salesperson to:
a. Leverage his/her growth initiatives to drive organic revenue growth by helping his/her channel partners to identify multiple tiers of prospects, deliver relevant messages to the right prospect at the right time, use a proven sales process, and leverage the marketing content and tools available;
b. Track execution of growth initiatives based on use activity, not forms filled out; and
c. Develop more effective and loyal sales channels.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

It is noted that the foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed:

1. A system for an interactive smart game plan for one or more growth initiatives comprising:
an electronic mail component configured to interact with one or more users by sending one or more personalized electronic mails having growth initiative information personalized to the user, pertaining to the growth initiative,
wherein the growth initiative information comprises at least one of, sales execution instructions, prospect information, and prospect background information.

2. The system of claim 1, further comprising a calendar component configured to display information relating to the growth initiative.

3. The system of claim 1, wherein the electronic mail component allows the user to receive personalized training material for the growth initiative.

4. The system of claim 1, wherein information relating to at least one of, the smart game plan and the information contained in the electronic mail are sent or delivered via at least one of, a world-wide web, a local area network and a wide area network.

5. The system of claim 1, further comprising one or more input components configured to allow a user to input information and/or requirements for the growth initiative.

6. The system of claim 1, wherein the electronic mail component is configured to deliver the growth initiative information to a user at a pre-selected or predetermined time and date.

7. The system of claim 1, wherein the growth initiative information is obtained from at least one database.

8. The system of claim 2, wherein the electronic mail component is configured to allow a user to input specific sales execution steps into the game plan and/or the calendar component.

9. The system of claim 2, wherein at least one of the electronic mail component and the calendar component is configured to display the growth initiative information to a user at a pre-selected or predetermined time and date.

10. The system of claim 2, wherein the growth initiative information or the information relating to the growth initiative comprises activities or events associated with a growth initiative.

11. The system of claim 10, wherein the activities or events are generated by the system and transferred to the calendar component.

12. The system of claim 1, wherein the growth initiative information or the information relating to the growth initiative comprises prospect information and the prospect information comprises a collection or a group of accounts or contacts for which a growth initiative is targeted.

13. The system of claim 7, wherein the database is a relational database.

14. A method for executing one or more growth initiatives of a smart game plan by one or more users comprising:
utilizing an electronic mail component to interact with one or more users by sending one or more automated and personalized electronic mails having growth initiative information personalized to the user, pertaining to the growth initiative,
wherein the growth initiative information comprises at least one of, sales execution instructions, prospect information, and prospect background information.

15. The method of claim 14, further comprising utilizing an electronic calendar component to display information relating to the growth initiative.

16. The method of claim 14, wherein the electronic mail component allows the user to receive personalized training material for the growth initiative.

17. The method of claim 14, wherein information relating to the smart game plan and/or the information contained in the electronic mail are sent or delivered via at least one of, a world-wide web, a local area network and a wide area network.

18. The method of claim 14, further comprising utilizing one or more electronic input components to allow a user to input information and/or requirements for the growth initiative.

19. The method of claim 14, wherein the electronic mail component is configured to deliver the growth initiative information to a user at a pre-selected or predetermined time and date.

20. The method of claim 14, wherein the growth initiative information is obtained from at least one database.

21. The method of claim 15, wherein the electronic mail component is configured to allow a user to input specific sales execution activities into the game plan and/or the electronic calendar component.

22. The method of claim 15, wherein at least one of the electronic mail component and the electronic calendar component is configured to display the growth initiative information to a user at a pre-selected or predetermined time and date.

23. The method of claim 15, wherein the growth initiative information or the information relating to the growth initiative comprises activities or events associated with a growth initiative.

24. The method of claim 23, wherein the activities or events are generated electronically and automatically, and are transferred to the electronic calendar component.

25. The method of claim 14, wherein the growth initiative information or the information relating to the growth initiative comprises prospect information and the prospect information comprises a collection or a group of accounts or contacts for which a growth initiative is targeted.

26. The system of claim 20, wherein the database is a relational database.

27. A computer program product readable by a computer system having computer-executable instructions that when executed cause a processor of the computer system to perform a method for generating one or more personal electronic mails in the execution of activities in an interactive smart game plan for one or more growth initiatives, the method comprising:
sending one or more personalized electronic mail to one or more users having growth initiative information personalized to the user, pertaining to the growth initiative,
wherein the growth initiative information comprises at least one of, sales execution instructions, prospect information, and prospect background information.

28. The computer program product of claim 27, further comprising displaying information relating to the growth initiative in an electronic calendar.

29. The computer program product of claim 27, wherein the electronic mail component allows the user to receive personalized training material for the growth initiative.

30. The computer program product of claim 27, wherein information relating to the smart game plan and/or the information contained in the electronic mail are sent or delivered via at least one of, a world-wide web, a local area network and a wide area network.

31. The computer program product of claim 27, wherein the method further comprises one or more electronic input components configured to allow a user to input information and/or requirements for the growth initiative.

32. The computer program product of claim 27, wherein the electronic mail component is configured to deliver the growth initiative information to a user at a pre-selected or predetermined time and date.

33. The computer program product of claim 27, wherein the growth initiative information is obtained from at least one database.

34. The computer program product of claim 28, wherein the electronic mail component is configured to allow a user to input specific sales execution steps into the game plan and/or the electronic calendar component.

35. The computer program product of claim 28, wherein at least one of, the electronic mail component and the electronic calendar component, is configured to display the growth initiative information to a user at a pre-selected or predetermined time and date.

36. The computer program product of claim 28, wherein the growth initiative information or the information relating to the growth initiative comprises activities or events associated with a growth initiative.

37. The computer program product of claim 36, wherein the activities or events are generated electronically and automatically, and are transferred to the electronic calendar component.

38. The computer program product of claim 27, wherein the growth initiative information or the information relating to the growth initiative comprises prospect information and the prospect information comprises a collection or a group of accounts or contacts for which a growth initiative is targeted.

39. The computer program product of claim 33, wherein the database is a relational database.

40. The system of claim 1, wherein the user or users is/are a salesperson.

41. The method of claim 14, wherein the user or users is/are a salesperson.

42. The computer program product of claim 27, wherein the user or users is/are a salesperson.
